(19) United States
(12) Patent Application Publication
(10) Pub. No.: US 2012/0050227 A1
(43) Pub. Date: Mar. 1, 2012

(54) OPTICAL TOUCH DEVICE

(75) Inventors: CHUN-CHENG KO, Tu-Cheng (TW); YUAN-HSU CHOU, Tu-Cheng (TW); TSUNG-HENG CHANG, Tu-Cheng (TW)

(73) Assignee: HON HAI PRECISION INDUSTRY CO., LTD., Tu-Cheng (TW)

(21) Appl. No.: 13/049,907

(22) Filed: Mar. 17, 2011

(30) Foreign Application Priority Data
Aug. 27, 2010 (TW) 99128755

(51) Int. Cl. G06F 3/042

(52) U.S. Cl. 345/175

(57) ABSTRACT

An optical touch device includes a touch panel, an infrared light pen, and an infrared camera module. The infrared light pen emits infrared light towards a surface of the touch panel. The touch panel includes a display panel and an infrared reflective element. The infrared reflective element is stacked on the display panel and faces the infrared camera module. The infrared reflective element reflects the infrared light to the camera module. The camera module captures images of the infrared light reflected by the infrared reflective element.

### BACKGROUND

1. Technical Field

The present disclosure relates to an optical touch device.

2. Description of Related Art

Touch panels mainly include a resistive type and a capacitive type touch panel. Both types of touch panels need to be designed with complex circuits. Thus, the structure and the process of the above two types of touch panels are complicated.

Therefore, it is desirable to provide a new touch panel, which can overcome the above-mentioned limitations.

### BRIEF DESCRIPTION OF THE DRAWINGS

FIG. 1 is an isometric view of an optical touch device according to an exemplary embodiment.

FIG. 2 is a cross-sectional view of the optical touch device of FIG. 1 taken along the line II-II thereof.

FIG. 3 shows a transmittance curve of an infrared reflective element of the optical touch device of FIG. 1.

FIG. 4 shows a reflectance curve of the infrared reflective element of the optical touch device of FIG. 1.

### DETAILED DESCRIPTION

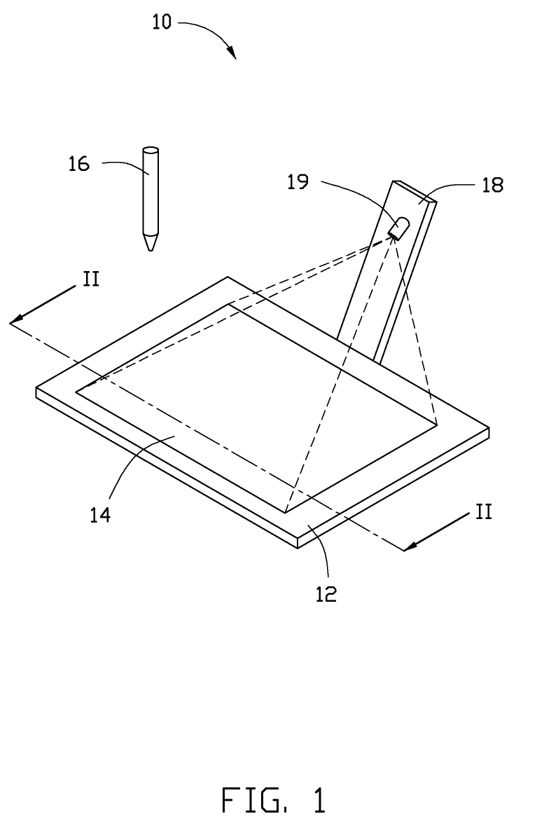

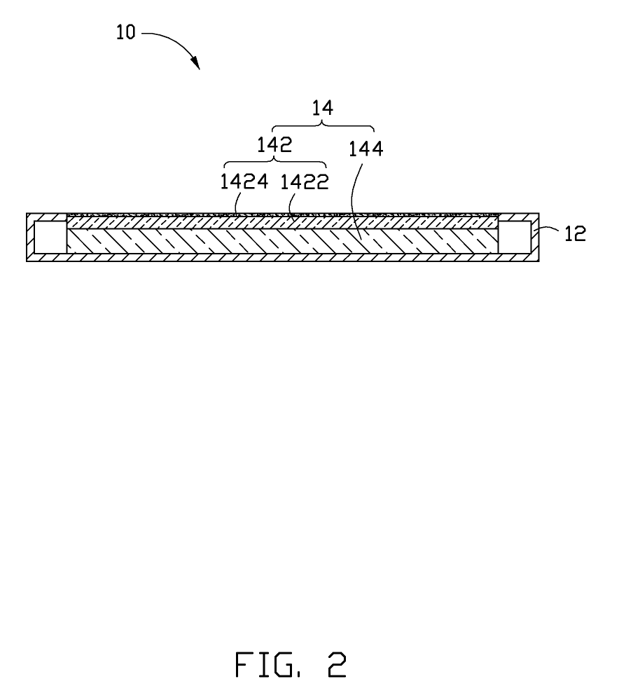

Referring to FIGS. 1-2, an optical touch device 10 includes a casing 12, a touch panel 14, an infrared light pen 16, a bracket 18 and a camera module 19 for capturing images of infrared light.

The casing 12 is substantially rectangular. The casing 12 defines a substantially rectangular chamber. The touch panel 14 is received in the chamber.

The bracket 18 is mounted on the casing 12. In alternative embodiments, the bracket 18 may be hinged to the casing 12. The camera module 19 is mounted on the bracket 18.

The light pen 16 may be a light emitting diode light pen 16. The light pen 16 is configured for emitting infrared light towards the touch panel 14, thus forming an infrared light spot on a surface of the touch panel 14. In the present embodiment, a wavelength of the infrared light emitted by the light pen 16 is about 850 nanometers.

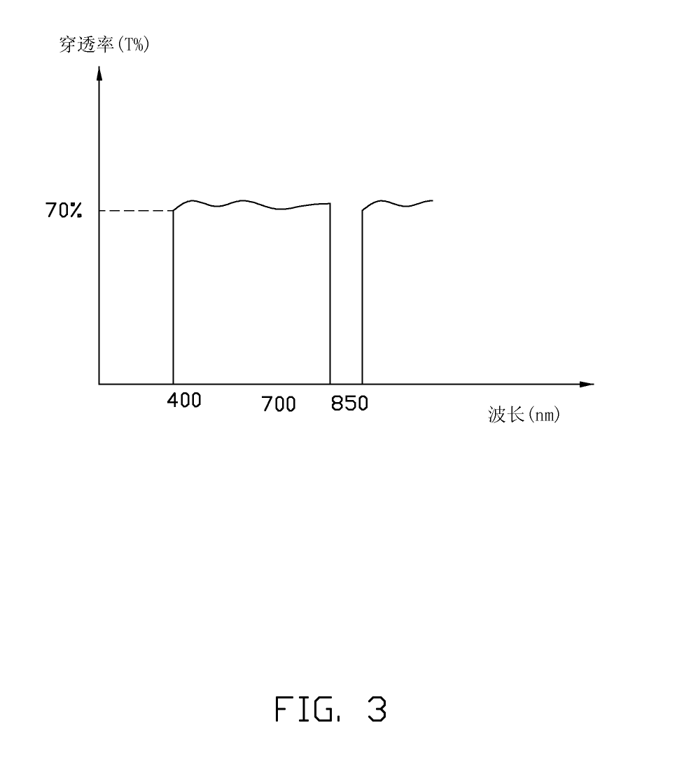

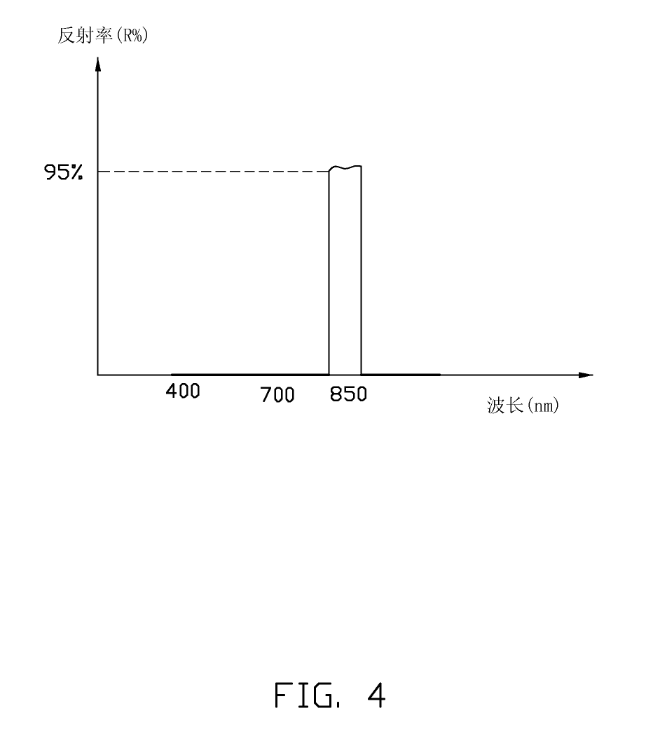

The touch panel 14 includes a display panel 144 and an infrared reflective element 142 formed on a surface of the display panel 144 facing the camera module 19. In the present embodiment, the display panel 144 is a liquid crystal display panel. In other embodiments, the display panel 144 may also be a field emission display panel. In the present embodiment, the infrared reflective element 142 includes a substrate 1422 and an infrared reflective film 1424 formed on the top surface of the substrate 1422 (i.e., a surface of the substrate 1422 facing the camera module 19). The substrate 1422 may be made of glass or plastic. A transmittance curve of the infrared reflective element 142 is shown in FIG. 3, and a reflectance curve of the infrared reflective element 142 is shown in FIG. 4. Referring to FIG. 3, a transmittance of the infrared reflective element 142 is 95% for visible light. As seen in FIG. 4, a reflectance of the infrared reflective element 142 is 95% for light with a wavelength of 850 nanometers. Accordingly, most of the infrared light emitted by the light pen 16 is reflected to the camera module 19.

The camera module 19 is configured for capturing images of the infrared light emitted by the light pen 16 and reflected to the camera module 19, thus obtaining a moving track of the infrared light spot. The camera module 19 then sends the moving track to an information processing device for processing and application. The information processing device can be, for example, a personal computer, a personal digital assistant, or a cell phone.

In other embodiments, the infrared reflective film 1424 may also be formed on the bottom surface of the substrate 1422. It is noteworthy that the substrate 1422 may be omitted. That is, the infrared reflective film is directly formed on the surface of the display panel 144 facing the camera module 19.

In the present embodiment, the optical touch device 10 is an optical writing pad. It is to be understood that the optical touch device 10 can be used in a laptop or a cell phone.

In the present embodiment, since the optical touch device 10 includes the infrared reflective element 142, a large portion of the infrared light emitted by the light pen is reflected to the camera module 19. Therefore, the sensitivity of the optical touch device 10 is improved.

While various embodiments have been described, it is to be understood that the disclosure is not limited thereto. To the contrary, various modifications and similar arrangements (as would be apparent to those skilled in the art), are also intended to be covered. Therefore, the scope of the appended claims should be accorded the broadest interpretation so as to encompass all such modifications and similar arrangements.

What is claimed is:

1. An optical touch device comprising:
a touch panel configured for receiving infrared light emitted from an infrared light pen;
an infrared camera module;
wherein the touch panel comprises a display panel and an infrared reflective element, the infrared reflective element is formed over the display panel and faces the infrared camera module, the infrared reflective element is configured for reflecting the infrared light to the camera module, and the camera module is configured for capturing images of the infrared light reflected by the infrared reflective element.

2. The optical touch device of claim 1, wherein the infrared reflective element comprises an infrared reflective film.

3. The optical touch device of claim 2, wherein the infrared reflective element further comprises a substrate, and the infrared reflective film is formed on the substrate.

4. The optical touch device of claim 1, wherein the infrared reflective element has a reflectance of 95% at the wavelength of about 850 nanometers.

5. The optical touch device of claim 1, wherein the infrared reflective element has a transmittance of 95% of visible light.

6. The optical touch device of claim 1, being an optical writing pad.

7. The optical touch device of claim 3, wherein the substrate is made of one of glass and plastic.

8. The optical touch device of claim 1, wherein the display panel comprises a liquid crystal display panel.

9. An optical touch device comprising:
a touch panel;
an infrared light pen configured for emitting infrared light towards the touch panel;
an infrared camera module;
wherein the touch panel comprises a display panel and an infrared reflective element, the infrared reflective element is formed over the display panel and faces the infrared camera module, the infrared reflective element is configured for reflecting the infrared light to the camera module, and the infrared camera module is configured for capturing images of the infrared light reflected by the infrared reflective element.

10. The optical touch device of claim 9, wherein the infrared reflective element comprises an infrared reflective film.

11. The optical touch device of claim 10, wherein the infrared reflective element further comprises a substrate, and the infrared reflective film is formed on the substrate.

12. The optical touch device of claim 9, wherein the infrared reflective element has a reflectance of 95% at the wavelength of about 850 nanometers.

13. The optical touch device of claim 9, wherein the infrared reflective element has a transmittance of 95% of visible light.

14. The optical touch device of claim 9, being an optical writing pad.

15. The optical touch device of claim 10, wherein the substrate is made of one of glass and plastic.

16. The optical touch device of claim 9, wherein the display panel comprises a liquid crystal display panel.
